(19) United States
(12) Patent Application Publication
(10) Pub. No.: US 2025/0098579 A1
(43) Pub. Date: Mar. 27, 2025

(54) Chaff and Straw Spreader for a Combine Harvester

(71) Applicant: AGCO do Brasil Soluções Agrícolas Ltda., Ribeirao Preto (BR)

(72) Inventors: Marcelo Carpenedo, Sapucaia do Sul (BR); Fabrício Carboni Tolotti, Canoas (BR); Lauro Bonetti, Canoas (BR); Steve O’Halloran, Hesston, KS (US)

(21) Appl. No.: 18/883,309

(22) Filed: Sep. 12, 2024

(30) Foreign Application Priority Data
Sep. 27, 2023 (GB) 2314841.4

(51) Int. Cl. A01D 41/12

(52) U.S. Cl. CPC A01D 41/1243

(57) ABSTRACT

A chaff and straw spreading system for a combine harvester has a chaff delivery system, a straw chopper and an impeller-based spreading unit. The impeller has a first section for receiving a chopped straw flow from the straw chopper and a second section for receiving a chaff flow from the chaff delivery system. By separating the impeller into different sections, mixing of the flows before the spreading unit is avoided, giving reduced material loss and improved spreading.

### FIELD

Embodiments of the present disclosure relate generally to combine harvesters, and in particular to a chaff and straw spreader used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

It is well known to install chaff spreaders for collecting and distributing MOG (i.e., chaff) ejected from the rear of the cleaning shoe. A chaff spreader for example comprises a pair of fan modules which eject the chaff at a tangent to a fan rotation axis.

It is also well known to install a straw chopper behind the threshing and separating apparatus for cutting straw, and to use a straw spreader to distribute the cut straw over the field. The straw spreader comprises rotary spinners (impellers) which drive the material into an output channel with a desired outlet direction. For example, a typical straw spreader has a pair of spinners, to actively accelerate the chopped straw and spread it at the back of the combine.

It is also known to enable the chaff from the chaff spreader to be fed into the straw chopper and/or straw spreader. For example, in a first mode, the chaff may be delivered to the straw chopper so that the chaff is spread together with the chopped straw, across the full cutting width. The straw spreading system provides a better distribution over the harvested field than a typical chaff spreader. In a second mode, a straw swath is formed, and the chaff spreader can be slowed down to mix the chaff with the straw swath to maximize the quantity and quality of straw. In a third mode, the chaff is spread before entering the straw chopper or spreader, by directing the chaff to the sides using deflectors.

In order to mix the chaff with the straw flow, the chaff can be routed to the straw spreading system through the straw chopper as mentioned above. It may instead be routed directly to the straw spreader (bypassing the straw chopper). However, in both cases, difficulties arise in combining the coarse straw flow and chaff flow as a result of a back pressure which is-generated by the straw chopper or by the chaff spreader impellers. This back pressure is normally high and has the power to block part of the chaff flow. This reduces the system performance, especially with respect to the material distribution over the field, because the material which has been blocked from entering the intended processing units falls to the ground, generating lines of accumulated material. These lines are visible and cause problems to the planting development.

There is a need for an improved mixing system for combining a chaff and straw flow to be distributed by a straw spreader.

### BRIEF SUMMARY

The invention is defined by the claims.

According to examples in accordance with the invention, there is provided a chaff and straw spreading system for a combine harvester including a chaff delivery system for receiving a chaff flow from a grain cleaning system of a combine harvester, a straw chopper for receiving a straw flow from a threshing and separating system of a combine harvester, and a spreading unit comprising an impeller, the impeller having a first section for receiving a chopped straw flow from the straw chopper and a second section for receiving a chaff flow from the chaff delivery system.

This spreading system delivers both chopped straw and chaff to an impeller-based spreading unit. The chaff is delivered without passing through the straw chopper. The two flows are however not mixed before the spreading unit. Instead, an impeller of the spreading unit is divided into two parts; one for receiving the chopped straw flow and one for receiving the chaff flow. In this way, material loss before the spreading unit, and which can occur when mixing flows, is avoided. The output appears to the end user as an evenly spread a single layer of material.

The chaff delivery system for example includes a chaff spreader. The chaff spreader for example includes first and second fan units. Each fan unit delivers flow to an associated one of the two impellers. Again, the fan units are driven to rotated in opposite directions.

A partition for example extends between an inlet to the first section of the impeller and an inlet to the second section of the impeller. Thus, mixing of flows is avoided before the spreading unit.

The first and second sections are for example stacked in a direction parallel to a rotation axis of the impeller. Thus, the two sections may be driven by a shared drive shaft about a common axis. In this way, the complexity of the spreading unit is not significantly increased while enabling two separate spreading functions to be implemented.

The spreading unit for example comprises first and second impellers each having first and second sections stacked in a direction parallel to a rotation axis of the respective impeller. The two impellers enable an even distribution of material to each side of a combine harvester. The two impellers are driven to rotate in opposite directions.

The spreading unit for example comprises a radially inwardly facing guide wall at a location around the second section of the impeller. This guide wall is used to shield the spread chaff flow from a back pressure generated by the second section of the impeller. This avoids loss of material where the chaff flow enters the spreading unit.

The guide wall is for example at an inlet to the second section of the impeller. It aims to alter the flow conditions so that the back pressure generated in the second section of the impeller does not tend to draw material flow away from the inlet to the impeller but instead acts to direct material flow into the impeller inlet.

The guide wall for example forms a radially outwardly extending pocket which defines a flow guide, wherein a flow exit from the pocket has a direction with a radially inward component.

The invention also provides a combine harvester having a crop cutting head, a threshing and separating system, a grain cleaning system for receiving the cut and threshed crop material, and the chaff and straw spreading system as defined above for receiving a chaff flow from the grain cleaning system and for receiving a straw flow from the threshing and separating system.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 a first known way to use a straw spreading system to additionally distribute chaff;

FIG. 4 shows a second known way to use a straw spreading system to additionally distribute chaff;

FIG. 5 shows in schematic form a chaff and straw spreading system;

FIG. 6 shows the chaff and straw spreading system in more detail from a first view;

FIG. 7 shows the chaff and straw spreading system in more detail from a second view;

FIG. 8 shows the flow of material around the spreading system;

FIG. 9 shows another view of the spreading part of the system; and

FIG. 10 shows another view of the overall chaff and straw spreading system.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a chaff and straw spreading system for a combine harvester, comprising a chaff delivery system, a straw chopper and an impeller-based spreading unit. The impeller of the spreading unit has a first section for receiving a chopped straw flow from the straw chopper and a second section for receiving a chaff flow from the chaff delivery system. By separating the impeller into different sections, mixing of the flows before the spreading unit is avoided, giving reduced material loss and improved spreading.

This disclosure relates to the design of a combined straw and chaff spreader for use with (or as an integral part of) a combine harvester. However, a general outline of a combine harvester will first be provided.

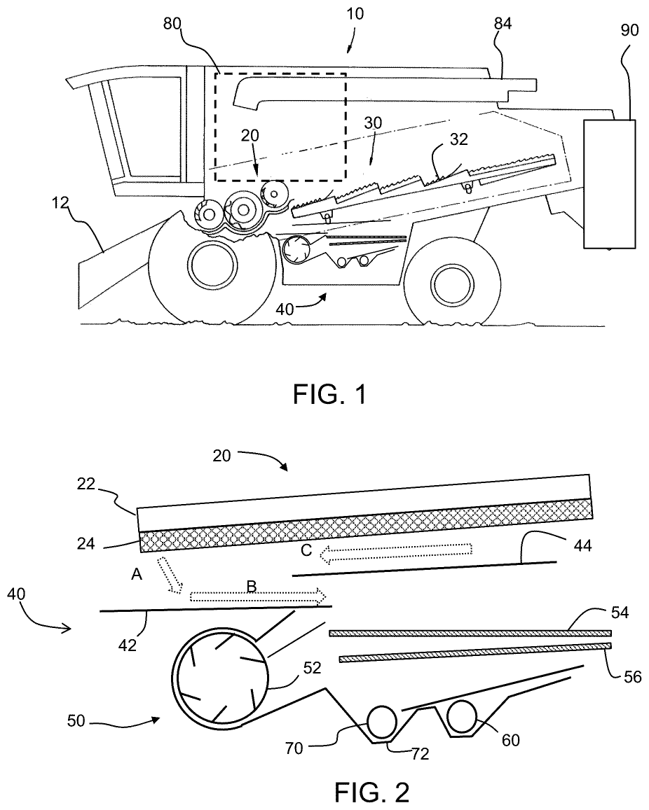

FIG. 1 shows a known combine harvester 10 to which the invention may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. This invention relates to a chaff and straw spreader 90 provided at the back of the combine harvester. As discussed above, a chaff spreader may be used for spreading the chaff in a uniform layer over the harvested field, or it may be used to mix the chaff with straw, either for distribution or for mixing with a straw swath.

As mentioned above, instead of tangential flow threshing (and separating), axial threshing (and separating) is also known, and the invention may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. A straw spreader and/or chopper may be provided to process the straw material as required, as represented schematically in FIG. 1 as unit 90.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

All material which has not been collected by the filling auger 70 or returns auger exits the back of the combine harvester and passes to a chaff spreader. The chaff spreader in known systems is a separate unit to the straw spreader. The chaff spreader receives the rejected material from the cleaning shoe whereas the straw spreader receives the rejected material from the separating apparatus. This invention however relates to a combined chaff and straw spreader, shown schematically in FIG. 1 as unit 90.

A chaff spreader for example comprises a fan for passing a large volume of air from the cleaning system. It for example is a simple device with as a single exit port. Chaff spreaders are also known with a first fan module for receiving chaff and distributing the chaff to a first direction (e.g., a first side of the combine harvester) and a second fan module for distributing the chaff to an opposite second direction (e.g., a second side of the combine harvester). The fan, or each fan module, has an internal paddle arrangement for delivering chaff to a chaff exit port. As the chaff is very light, it is difficult to spread far away, and the main function of the chaff spreader is to process the air flow from the cleaning system.

A typical design of a straw spreading system comprises a rotary cutter and a straw spreader with first and second impellers. The impellers accelerate the flow and deliver the flow to deflectors which are designed to achieve a desired distribution of chopped straw over the field. The straw spreader has (and needs) more spreading precision, and typically has different segments and deflectors for this purpose, or even an oscillating deflector. The chopped straw passing through the straw spreader has about 80% of the MOG and is heavier than the 20% of the MOG passing through a chaff spreader. A straw spreader for example has a higher revolution speed than a chaff spreader and is optimized more for a mechanical contact between the paddles and straw than for a fluid contact.

This disclosure relates to the chaff and straw spreading function. In particular, the invention relates to a design in which an output flow from a chaff delivery system (which in some examples is a chaff spreader) is provided to a straw spreading system which spreads chopped coarse straw received from the separating apparatus of the combine.

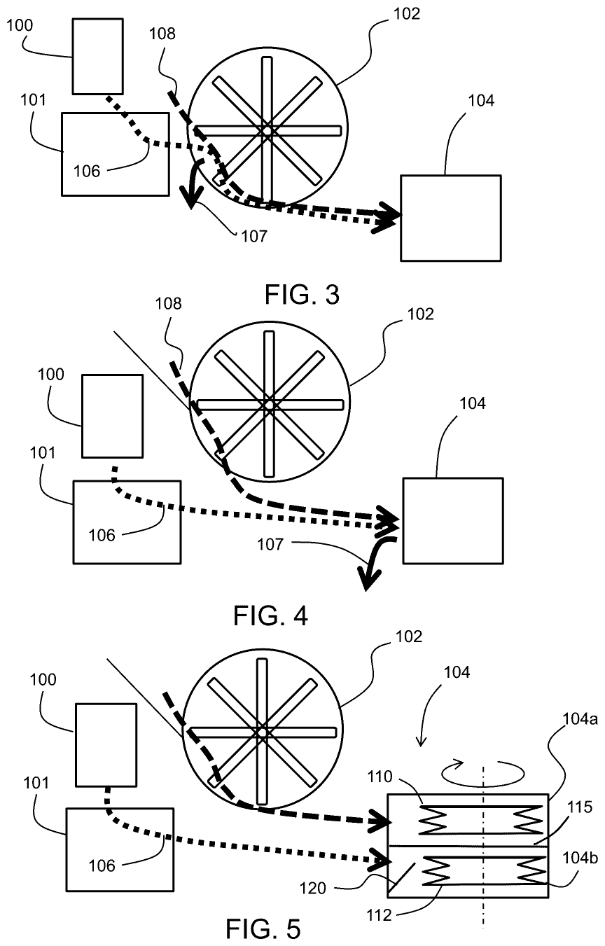

It is already known to use a straw spreading system to additionally distribute chaff. Indeed, there are two known options for routing the chaff from a chaff spreader to a straw spreading system. FIG. 3 shows a first option, and schematically shows the cleaning shoe 100, chaff spreader 101, straw chopper 102 and straw spreader 104.

In FIG. 3, the chaff flow 106 is delivered by the chaff spreader 101 to the straw chopper 102, and it mixes with the chopped straw flow 108 at the inlet to the straw chopper 102. The chaff is then spread as a combined chopped coarse straw and chaff flow.

FIG. 4 shows a second option in which the chaff flow 106 is delivered to the straw spreader 104 without passing through the straw chopper 102. The chaff is for example delivered below the straw chopper (since the separating apparatus and straw chopper are above the cleaning shoe) and fed directly to the straw spreader. The chaff flow 106 mixes with the chopped straw flow 108 at the inlet to the straw spreader 104.

As mentioned above, back pressure is generated by straw chopper blades and by straw spreader impellers, and this can block the desired flow of chaff to the straw chopper or spreader. FIGS. 3 and 4 show the path of this blocked chaff flow as 107.

This invention relates in particular to a design in which chaff is delivered directly to the straw spreader, as shown in FIG. 4, without contact with the straw chopper knives. This configuration is preferred because the chaff does not need any processing to improve the material quality, as it is already a fine material and is in a form suitable to be spread over the field.

FIG. 5 shows in schematic form the chaff spreading system. It again shows the cleaning shoe 100, chaff spreader 101, straw chopper 102 and straw spreader 104. The straw spreader 104 has first and second spreading sections 104a, 104b. The first spreading section 104a is for receiving chopped straw from the straw chopper 102 and the second spreading section 104b is for receiving chaff from the chaff spreader 101.

Each straw spreading section 104a, 104b has its own impeller section. In particular, the two impeller sections are stacked so that the impeller is provided with an upper portion 110 and a lower portion 112 to receive the material from straw chopper and chaff spreader, respectively. A shaped element or plate 115 is provided (FIGS. 5 & 6) between the upper portion 110 and lower portion 112, that is between the portions of each impeller receiving the respective straw chopper and chaff spreader materials. By providing separate spreading sections 104a, 104b, either side of shaped element 115 the material from the straw chopper and from the chaff spreader are no longer mixed at the inlet side, so that the back pressure generated by the straw chopper 102 does not interfere with the chaff flow.

There is a back pressure generated by the lower portion 112 of the impeller (which receives the chaff spreader flow). There is also a mixing of flows within the second spreading section comprising a main flow which is expelled directly and a return flow which completes a full revolution around the spreading section (and is thus not directly expelled). This return flow acts upon a guide wall 120 which controls the direction of this return flow (of air and material) in order to direct it away from the chaff flow, enabling the chaff flow to be fed to the straw spreader impeller with reduced loss.

The guide wall 120 thus functions to counter the back pressure generated by the system. The back pressure is not eliminated as it is an intrinsic characteristic of the rotating chopper and impeller, but the guide wall enables the chaff flow to be fed inside the straw spreader with reduced blockage, thereby providing improved performance in terms of the amount of material being managed by the spreading system. This is explained in more detail below.

The use of a chaff spreader upstream of the chaff and straw spreading system enables the cleaning system to be at a distance from the chaff and straw spreading system in that the chaff spreader accelerates and guides the chaff to the spreader. However, any suitable delivery system may be used to pass MOG from the cleaning system to the chaff and straw spreading system, such as a belt or any other device to accelerate and guide the material from the cleaning shoe to the spreader.

When a chaff spreader is used (i.e. a fan based delivery system) it enables a flow of air from the cleaning system, and it may also be used to provide different delivery options, for example to divide the chaff flow (to the sides when windrowing) or to blow the chaff into a swath.

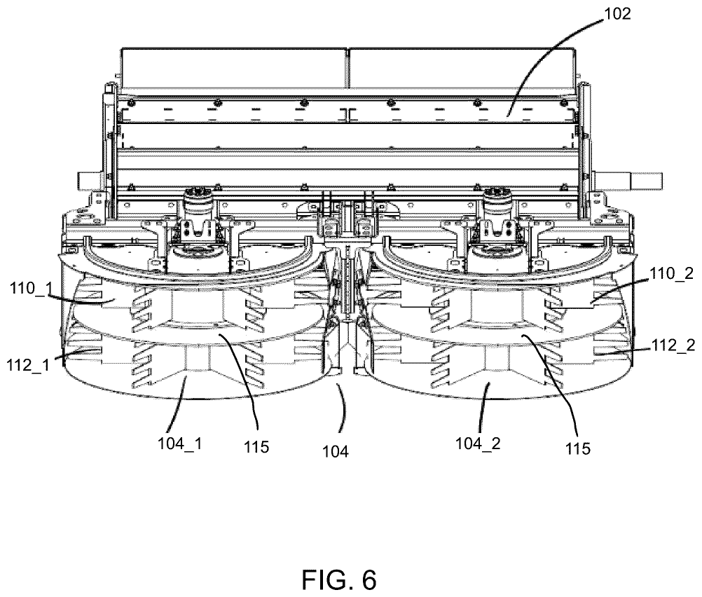

FIG. 6 shows the chaff and straw spreader 104 in more detail. It is downstream of the straw chopper 102 and comprises two spreading units 104_1 and 104_2 each with their own impeller. The impeller of the first straw spreading unit 104_1 has a first section 110_1 and a second section 112_1 and the impeller of the second straw spreading unit has a first upper section 110_2 and a second lower section 112_2. In each impeller comprises, the first upper section 110_1,110_2 and the second lower section 112_1, 112_2 can be seen to provide upper and lower paddles respectively on either side of each side of a shaped element or plate 115.

The impellers each have a rotation axis which is common to the two sections. This rotation axis is perpendicular to a rotation axis of the straw chopper 102. The straw chopper has a transverse rotation axis delivering cut straw as a tangential flow into inlets of the first sections 110_1, 110_2 of the two impellers.

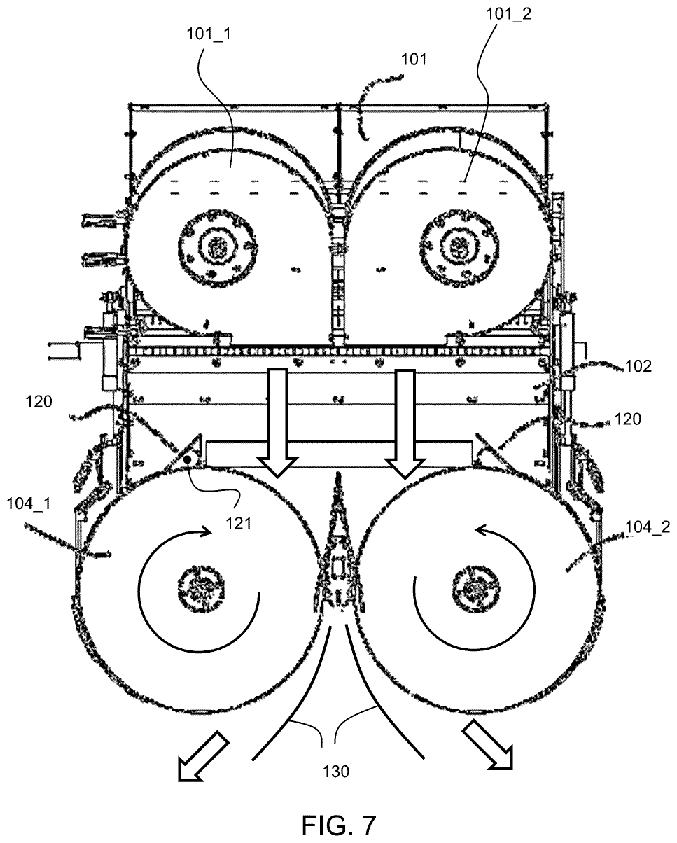

FIG. 7 shows that the chaff spreader also comprises two counter rotating fan units 101_1, 101_2. Each fan unit has an outlet that directs flow toward an inlet of an associated one of the impellers, in particular to an inlet of the second section 112_1, 112_2 of the impeller of an associated straw spreading unit 104_1,104_2.

FIG. 7 shows the location of the guide wall 120. The lower paddles of the impellers direct the material from the center to outward regions, and hence there is an intrinsic pressure forcing all the material (air+solid materials) to be thrown radially out of the impeller. In some radially outer regions of the impeller there are deflectors 130 which are used to direct the material to the desired spreading direction.

The guide wall 120 of each impeller functions as a material brake to the flow of material around the spreading section, in particular material (and air) that does not escape from the spreading section but instead follows a return path around the spreading section. The guide wall defines an internal pocket 121, with greater radius than the radius of the housing around the impeller, into which the air and material flow will be directed by the centrifugal forces. The inward facing shape of the pocket guides the flow of that air and material, in particular so that when the flow joins the main flow from the chaff spreader, there is improved mixing with reduced loss.

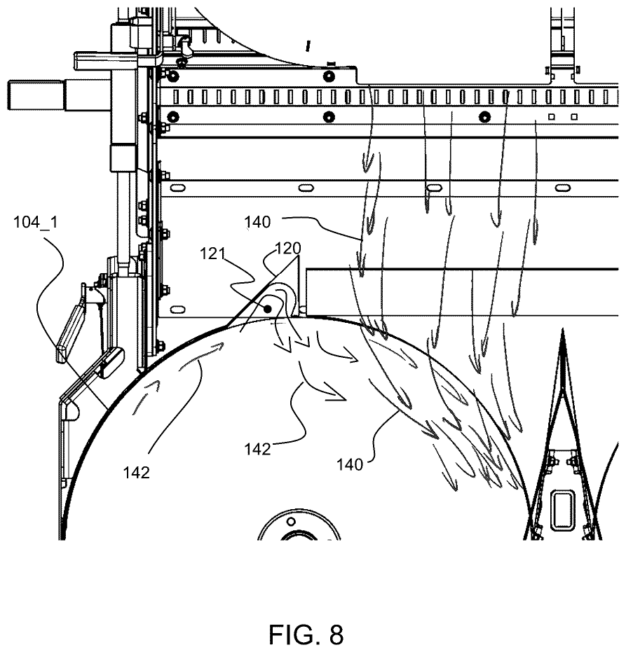

FIG. 8 shows the main flow from the chaffer spreader as arrows 140 and the returning flow as arrows 142. The returning flow comprises air and material. The inner surface of the pocket 121 has a surface for redirecting the flow away from the outer circumference of the outer housing as well as reducing the energy of the flow by the braking function. In this way, the flow pressure of the return flow is reduced. The flow is redirected to have a radially inward component as well as having reduced pressure.

The mixing of the return flow and the main flow reduces the efficiency of the spreading system. The guide wall 120 reduces the resulting efficiency loss. It directs the return flow of air and material so that there is smooth feeding of the return flow into the main flow. This flow redirecting process is continuous while the machine is harvesting.

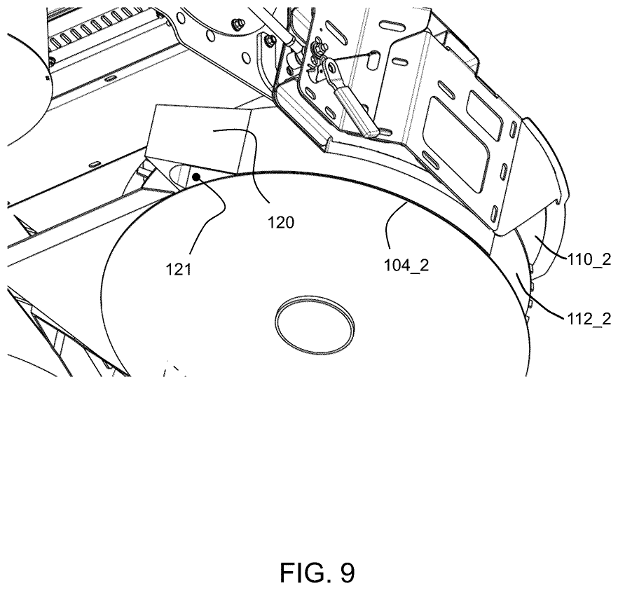

FIG. 9 is a perspective view of the underside of the spreading unit, showing that the guide wall 120 has approximately the same height as the impeller (of the second section), and thus extends the full height of the outer housing around the impeller of the second section.

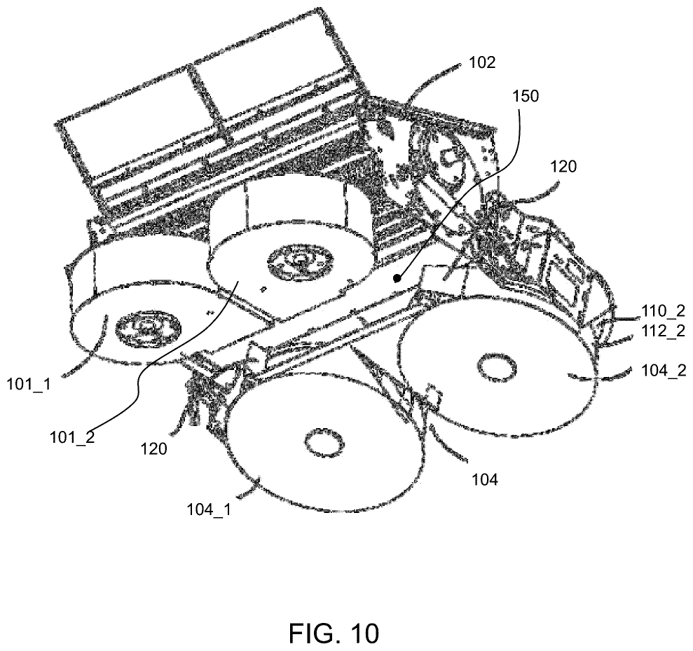

FIG. 10 shows another view of the spreading system. It shows a partition wall 150 that separates the inlets to the first and second sections of the impellers so that flow mixing at the inlet side of the straw spreader is avoided.

The mixing of chaff and straw to the straw spreader has been explained above. This may only be one mode of operation of the system. For example, the chaff spreader may be controllable to distribute chaff without passing through the straw spreader, or the chaff spreader may be controllable to mix the chaff with a straw swath.

The invention may be applied to any design of combine harvester. Thus, it does not rely on any particular threshing, separating or cleaning design, and the examples above are only given to aid overall understanding.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A chaff and straw spreading system for a combine harvester, comprising:
a chaff delivery system for receiving a chaff flow from a grain cleaning system of a combine harvester;
a straw chopper for receiving a straw flow from a threshing and separating system of a combine harvester; and
a spreading unit comprising an impeller, the impeller having a first section for receiving a chopped straw flow from the straw chopper and a second section for receiving a chaff flow from the chaff delivery system, the first section and the second section having upper and lower paddles respectively on either side of each side of a shaped element.

2. The system of claim 1, wherein the chaff delivery system comprises a chaff spreader.

3. The system of claim 2, wherein the chaff spreader comprises first and second fan units.

4. The system of claim 1, comprising a partition extending between an inlet to the first section of the impeller and an inlet to the second section of the impeller.

5. The system of claim 1, wherein the first and second sections are stacked in a direction parallel to a rotation axis of the impeller.

6. The system of claim 1, wherein the spreading unit comprises first and second impellers in which the first and second sections are stacked in a direction parallel to a rotation axis of the respective impeller.

7. The system of claim 1, wherein the spreading unit comprises a radially inwardly facing guide wall at a location around the second section of the impeller.

8. The system of claim 7, wherein the guide wall is located adjacent at an inlet to the second section of the impeller.

9. The system of claim 8, wherein the guide wall forms a radially outwardly extending pocket which defines a flow guide, wherein a flow exit from the pocket has a direction with a radially inward component.

10. A combine harvester comprising:
a crop cutting head;
a threshing and separating system;
a grain cleaning system for receiving the cut and threshed crop material; and
the chaff and straw spreading system of claim 1 for receiving a chaff flow from the grain cleaning system and for receiving a straw flow from the threshing and separating system.
